(19) United States
(12) Patent Application Publication
(10) Pub. No.: US 2026/0299543 A1
(43) Pub. Date: Oct. 1, 2026

(54) WEAR LEVELING FOR PROGRAMMABLE RESOURCES IN PROGRAMMABLE LOGIC DEVICES

(71) Applicant: Telefonaktiebolaget LM Ericsson (publ), Stockholm (SE)

(72) Inventors: Farrokh GHANI ZADEGAN, Lund (SE); Patrik ÅBERG, Lund (SE)

(21) Appl. No.: 19/163,102

(22) PCT Filed: Nov. 30, 2023
(86) PCT No.: PCT/EP2023/083798

§ 371 Date: Sep. 8, 2025

(30) Foreign Application Priority Data
Mar. 13, 2023 (WO) PCT/EP2023/056370

(51) Int. Cl. G05B 19/05

(52) U.S. Cl. CPC G05B 19/056; G05B 2219/13004

(57) ABSTRACT

A method and apparatus are disclosed. A device including processing circuitry in communication with a programmable logic device (PLD) is provided. The PLD includes a plurality of physical resources and a plurality of sensors, each having a wear characteristic measurable by a corresponding one of the plurality of sensors. The device is configured to determine at least one ageing curve associated with the plurality of physical resources, the at least one ageing curve including a rate of change of the wear characteristic. The device is configured to select a first product bit-file of a plurality of functionally equivalent product bit-files, the selected product bit-file being configured to cause a set of the plurality of physical resources of the PLD to be used based on the determined at least one ageing curve. The device is configured to configure the PLD to execute the first product bit-file.

### TECHNICAL FIELD

The present disclosure relates to Programmable Logic Devices (PLDs), and in particular, to wear leveling for programmable resources in PLDs.

### BACKGROUND

The fast pace of technological progress has made it necessary to be able to upgrade the functionality of existing products in the field of telecommunication, computing, cloud servers, data centers and so on. By upgrading the functionality more features can be added, newer standards can be supported, etc. Such need for upgradability is not limited to software, as many systems are dependent on hardware acceleration (e.g., to meet the demands for high-performance computation and the real-time requirements), and thus may also require the hardware acceleration features to be upgradable. A PLD is a suitable candidate for offering such upgradable acceleration capabilities due to its versatility and the ability to be (re)programmed after manufacturing. One example of a PLD is a Field Programmable Gate Array or FPGA. Due to their re-programmability, PLDs have also found their way into the offerings of cloud service providers as hardware accelerators.

Billions of devices are connected to the cloud in what is referred to as the Internet of Things (IoT). These devices in the IoT are typically referred to as IoT devices. To adapt different applications and radio access technologies, hardware and software implementation of IoT devices is required to be flexible. Due to its ability to be (re)programmed after manufacturing, a PLD is similarly a good candidate for implementation of an IoT device.

A programmable logic device (PLD) is an integrated circuit that can be programmed or reprogrammed after manufacturing by a customer or designer. The PLD may be programmed using a Hardware Description Language (HDL). In particular, an HDL is used to define the behavior of the PLD. Then, using an electronic design automation tool, a technology-mapped netlist is generated. The netlist is then fit to the PLD architecture, usually using proprietary software of the PLD manufacturer. Once design and validation is complete, the bit-file, bitstream, or binary file, generated by the proprietary software of the PLD manufacturer, is loaded into the PLD via a serial interface or external memory. In this manner, the PLD can be programmed or reprogrammed as desired.

PLDs may be subject to ageing (e.g., degradation in performance over time) via mechanisms such as Bias Temperature Instability (BTI), Hot-Carrier Injection (HCI), Electromigration (EM), etc. The speed and pattern of ageing across an PLD's die may vary depending on environmental conditions (such as temperature during operation) as well as usage patterns. The usage pattern may be particularly relevant because some degradation mechanisms affect the device when there is circuit activity. This type of ageing is referred to as “dynamic ageing”. Other mechanisms, on the other hand, may affect the device when voltage is applied but there is no circuit activity. This type of ageing is referred to as “static ageing”. Therefore, speeds and patterns of ageing in an PLD's building blocks/physical resources may vary considerably between units of the same exact product, even if the units are programmed with the same exact bit-file.

Some existing systems have addressed wear leveling for PLDs, but these existing systems focus only on a PLD's internal memories, i.e., only on PLDs with non-volatile type of memories. It has been proposed to use a placement algorithm for insertion of ageing monitors in PLD designs, and to apply wear leveling to PLDs.

In one existing system, for example, a method is provided for wear leveling by creating switching activity in PLD resources that are not used by the user's functional logic. This wear-leveling scheme has, however, several drawbacks including: (1) the scheme does not necessarily achieve wear leveling by reducing the degradation, as it induces EM- and HCI-based ageing in the unused resources; (2) the scheme may result in higher power consumption, as it creates extra switching activity (that is, beyond what is needed for the user's functional logic); and (3) the scheme does not address static ageing that occurs within the resources partially used by user's functional logic. In this regard, it should be noted that only a small portion of transistors inside a lookup table (LUT), which is one type of programmable resource inside a PLD, might be used by the user's logic, whereas all transistors may be powered on and may be under voltage stress (e.g., “powered on”, as contrasted to a transistor being “on” (allowing current to pass through its channel) and “off” blocking current through its channel).

In other existing systems, dedicated bit-files are used for monitoring of ageing with the purpose of predicting end-of-life for PLDs, but such systems do not address wear leveling.

### SUMMARY

Some embodiments advantageously provide methods, systems, and apparatuses for wear leveling for programmable resources in PLDs.

Various physical phenomena cause ageing of the circuitry. Some ageing occurs when thew PLD circuitry is powered on even if no signaling is occurring. Since ageing effects are becoming more pronounced as device feature sizes decrease, it is becoming important to monitor for ageing and take necessary measures to prolong the lifetime of the device. On the other hand, since speed and patterns of ageing across an PLD's die are dependent on the usage and environmental conditions, any such measure should be tailored to (and be recurrent for) each unit.

Thus, embodiments of the present disclosure may prolong the life of PLDs, e.g., by periodically swapping the PLD's bit-file with another bit-file that is functionally equivalent, but which uses different resources. Monitoring bit-files contain a multitude of circuits/modules, referred to as sensors, where each sensor measures the delay for a set of physical resources. The swapping may be achieved, e.g., through one or more of the following techniques:
for each circuit design (i.e., product), create a repository of functionally equivalent PLD bit-files, where each bit-file is built using a different random seed (so that diverse sets of PLD resources are utilized in each bit-file),
monitor for ageing for each PLD unit separately and periodically, and
based on the periodic monitoring results, swap the monitored units' bit-files with bit-files from the repository such that the PLD resources that are thus more affected by ageing become subject to less degradation in the next bit-file
extend the lifetime of an PLD
detecting ageing and trying to “rejuvenate” or “level out” this ageing, inside the PLD, so it prolongs the life of a device.

Embodiments of the present disclosure may consider causes of ageing and may prolong lifetime by, e.g., monitoring the extent of ageing in a single PLD, and based on the monitoring results, programming/configuring the PLD with a different bit stream/bit-file, which is functionally equivalent, i.e. defines an electric circuit using partly or entirely different parts of the PLD than the previous bit-file, but performs the same function as the circuit defined by the bit-file being replaced. The bit-file which is determined/selected may be based on the previous PLD configuration and/or monitoring information, which is on a per-product basis. Embodiments of the present disclosure may consider the entire PLD circuit, not just the memory, and may combine the state of ageing in the memory circuitry together with other parts of the circuit to potentially extend the lifetime of the circuit.

Thus, some embodiments of the present disclosure may address the problem of wear leveling for programmable resources in an PLD via periodic monitoring of resources and allowing the frequently used resources to rest. Wear leveling may consider one or more of:
dynamic ageing;
static ageing;
power gating; and
delay times (e.g., the time needed for signals to propagate from one physical resource to another), which may correspond to, for example, frequency measurements in cases where delay is defined as the inverse of the measured frequency.

Further, some embodiments of the present disclosure may configure multiple monitoring bit-files for increased coverage of the physical resources inside the PLD.

Some embodiments of the present disclosure may provide one or more of the following benefits:
increased PLD lifetime by performing wear leveling;
   wear leveling in some embodiments may be achieved, for example, by removing/reducing the stress from much-used resources rather than inducing ageing on less-used resources;
may function independently of one or more of:
   adding ageing monitors to the functional design; and
   modifying the synthesis and place and route algorithms;
may utilize dedicated monitoring bit-files, which allow for more comprehensive coverage of programmable resources;
may utilize rotation of multiple monitoring bit-files so that even greater monitoring coverage may be achieved; and
may utilize power domains for wear-leveling and/or monitoring of wear.

In some embodiments of the present disclosure, a product bit-file may be selected based on the speed of ageing. According to at least one embodiment, information collected from other PLDs (i.e., not directly related to a given PLD) is used, which may improve the wear leveling algorithm. According to at least one embodiment, factors such as: the effect of temperature on the measurements; a time period that an PLD may have been taken out of operation; and/or the initial state of PLDs as represented by, e.g., the surface plot obtained in the first (i.e., an initial) measurement are taken into account.

In at least one embodiment, calculating the cost function associated with each product bit-file may be based on a history of measurements for the sensors (in contrast to using only the latest measurement), and the calculation may take the speed of ageing into account.

In at least one embodiment, curves relating to other PLDs than a given PLD, such as ageing curves, may be compared using a “floor” measurement based on an initial measurement performed for each sensor on each PLD. This may be used to normalize future measurements, which can be used to predict how the current curve will look like in the future.

In at least one embodiment, the effect of temperature on the measurements may be compensated for. For each measurement, the ambient temperature may be recorded as well as the temperatures within the PLD. This may be used to identify comparable measurement curves to be used when predicting how the current curve will look like in the future, as described elsewhere herein.

In at least one embodiment, in situations where the ageing monitoring measurements may be unable to be performed frequently, e.g., when there is always load on the PLD, the wear leveling may not be able to be performed effectively, thus leading to shorter life span for the PLD. To address this situation, measurements from other similar PLDs may be used to improve the estimations on the current speed of ageing in the PLDs that have fewer measurement points in their ageing curves.

In at least one embodiment, operating time as time base for the curves being sampled for each sensor are used to account for PLDs that may have been taken out of operation for periods of time.

Advantages of various embodiments described herein may include improved decision-making analytics for improved wear leveling, thus further prolonging the lifespan of PLDs in products in, e.g., the field and in data centers, as well as other applications using PLDs for, e.g., software acceleration. That is, increased efficiency in the wear leveling algorithm may be achieved, resulting in longer product lifetimes and increased sustainability.

According to a first aspect of the present disclosure, a device, such as a wear-leveling device, is provided. The device is configured to determine at least one ageing curve associated with the plurality of physical resources, the at least one ageing curve including a rate of change of the wear characteristic. The device is configured to select a first product bit-file of a plurality of functionally equivalent product bit-files, the selected product bit-file being configured to cause a set of the plurality of physical resources of the PLD to be used based on the determined at least one ageing curve. The device is configured to configure the PLD to execute the first product bit-file.

According to one or more embodiments of this aspect, the at least one ageing curve includes a predicted future ageing curve. According to one or more embodiments of this aspect, the at least one ageing curve is determined based on a historical ageing curve of the PLD. According to one or more embodiments of this aspect, the historical ageing curve is based on the PLD having been out of operation for at least one time period. According to one or more embodiments of this aspect, the at least one ageing curve is based at least in part on a historical ageing curve of at least one other PLD. According to one or more embodiments of this aspect, the at least one other PLD has a longer operational life than an operational life of the PLD. According to one or more embodiments of this aspect, the at least one ageing curve is determined based on a discrepancy between an initial time delay of one of the plurality of physical resources at an initial state of the PLD, and a present time delay of the one of the plurality of physical resources. According to one or more embodiments of this aspect, the ageing curve is determined based on temperature information. According to one or more embodiments of this aspect, the temperature information includes a temperature-compensated delay corresponding to each of the plurality of resources. According to one or more embodiments of this aspect, the temperature information corresponds to a temperature model based on at least one of: at least one analytical model; at least one post place-and-route timing simulation performed at each of a plurality of temperatures; and an initial measurement at each of a plurality of temperatures performed in a climate control chamber. According to one or more embodiments of this aspect, the at least one ageing curve is determined using a monitoring bit file, the first product bit-file being selected based on a determined ageing of the monitoring bit file.

According to another aspect of the present disclosure, a method implemented in a device, such as a wear-leveling device, is provided. The method includes determining at least one ageing curve associated with the plurality of physical resources, the at least one ageing curve including a rate of change of the wear characteristic. The method includes selecting a first product bit-file of a plurality of functionally equivalent product bit-files, the selected product bit-file being configured to cause a set of the plurality of physical resources of the PLD to be used based on the determined ageing curve. The method includes configuring the PLD to execute the first product bit-file.

According to one or more embodiments of this aspect, the at least one ageing curve includes a predicted future ageing curve. According to one or more embodiments of this aspect, the at least one ageing curve is determined based on a historical ageing curve of the PLD. According to one or more embodiments of this aspect, the historical ageing curve is based on the PLD having been out of operation for at least one time period. According to one or more embodiments of this aspect, the at least one ageing curve is based at least in part on a historical ageing curve of at least one other PLD. According to one or more embodiments of this aspect, the at least one other PLD has a longer operational life than an operational life of the PLD. According to one or more embodiments of this aspect, the at least one ageing curve is determined based on a discrepancy between an initial time delay of one of the plurality of physical resources at an initial state of the PLD, and a present time delay of the one of the plurality of physical resources. According to one or more embodiments of this aspect, the at least one ageing curve is determined based on temperature information. According to one or more embodiments of this aspect, the temperature information includes a temperature-compensated delay corresponding to each of the plurality of resources. According to one or more embodiments of this aspect, the temperature information corresponds to a temperature model based on at least one of: at least one analytical model; at least one post place-and-route timing simulation performed at each of a plurality of temperatures; and an initial measurement at each of a plurality of temperatures performed in a climate control chamber. According to one or more embodiments of this aspect, the at least one ageing curve is determined using a monitoring bit file, the first product bit-file being selected based on a determined ageing of the monitoring bit file.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example architecture illustrating a programmable logic device wear leveling system including a wear leveling device connected to a programmable logic device according to the principles in the present disclosure;

FIG. 2 is a block diagram of a wear leveling device communicating with a programmable logic device according to some embodiments of the present disclosure;

FIG. 3 is a flowchart of an example process in a wear leveling device for wear leveling the programmable resources in a PLD according to some embodiments of the present disclosure;

FIG. 4 is an example graph of delay measurements according to some embodiments of the present disclosure;

FIG. 5 is an example graph of delay measurements according to some embodiments of the present disclosure;

FIG. 6 is an example graph of delay measurements according to some embodiments of the present disclosure;

FIG. 7 is an example graph of estimated aging curves according to some embodiments of the present disclosure;

FIG. 8 is an example graph of historical delay data according to some embodiments of the present disclosure;

FIG. 9 is an example graph of historical delay data according to some embodiments of the present disclosure;

FIG. 10 is an example graph of measured delay data according to some embodiments of the present disclosure;

FIG. 11 is an example graph of temperature-dependent component of the delay according to some embodiments of the present disclosure;

FIG. 12 is an example graph of temperature compensation according to some embodiments of the present disclosure;

FIG. 13 is a flowchart of another example process in a wear leveling device for wear leveling the programmable resources in a PLD according to some embodiments of the present disclosure;

FIG. 14 is a flowchart of another example process in a wear leveling device for wear leveling the programmable resources in a PLD according to some embodiments of the present disclosure;

FIG. 15 is a block diagram of an example two-input LUT of a PLD according to some embodiments of the present disclosure; and

FIG. 16 is a schematic diagram of an example resource map in a PLD according to some embodiments of the present disclosure.

### DETAILED DESCRIPTION

Before describing in detail example embodiments, it is noted that the embodiments reside primarily in combinations of apparatus components and processing steps related to wear leveling for programmable resources in PLDs of which an FPGA is an example. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”. “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

As used herein, the term “wear-leveling” with reference to “device” is not intended to limit the type of device which may implement the wear-leveling functionalities described herein, and may be implemented, e.g., in one or more of a computer processor, computer system, embedded system, host computer, server, wireless device, network node, cloud-based server, etc. For example, a device which configures a PLD with product bit-files, monitoring bit-files, etc., according to embodiments described herein, may be considered a wear-leveling device.

As used herein, the term “bit-file” is intended to refer to any configuration file, data structure, etc., for configuring/building/compiling/etc., a PLD or similar device, such as a bit-file, bitstream, or similar.

Some embodiments provide apparatuses, methods, and systems for wear leveling for programmable resources in PLDs.

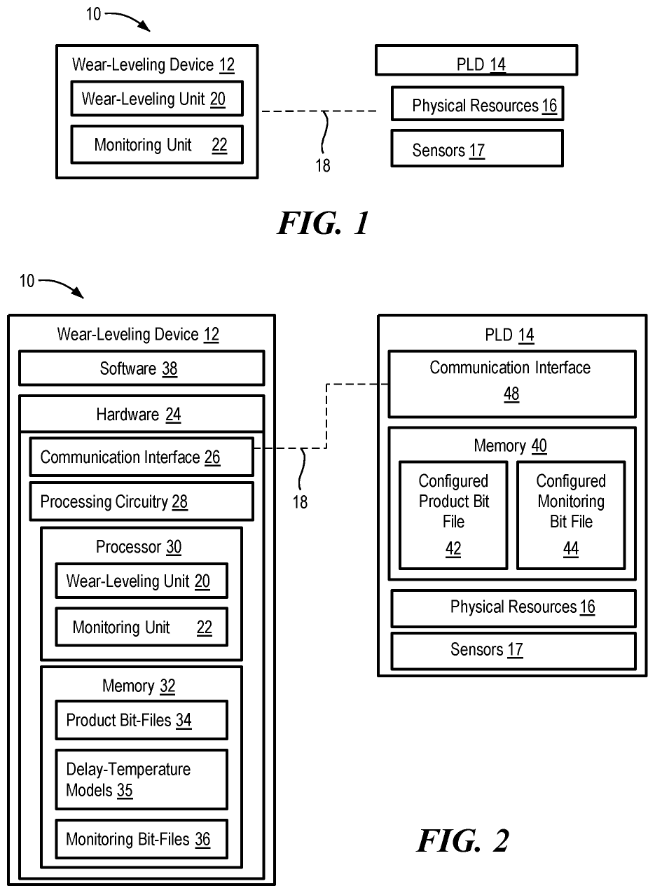

Referring now to the drawing figures, in which like elements are referred to by like reference numerals, there is shown in FIG. 1 a schematic diagram of a PLD wear-leveling system 10, according to an embodiment, which includes a wear-leveling device 12 and a PLD 14 which includes physical resources 16. In some embodiments, the PLD 14 may be an FPGA, whereas in other embodiments, the PLD 14 may be a device, such as an IoT device or radio node in a wireless communication network, which includes one or more PLDs 14 as sub-components. The wear-leveling device 12 may communicate with the PLD 14 via a wired and/or wireless communication link 18.

Wear-leveling device 12 may include a wear-leveling unit 20 configured for supporting wear-leveling of the programmable resources in a PLD 14. Wear-leveling device 12 may include a monitoring unit 22 configured for supporting monitoring/measuring one or more physical parameters/values/characteristics/etc. of one or more physical resources of a PLD 14.

Non-limiting example implementations, in accordance with one or more embodiments, of control device wear-leveling system 10 discussed in the preceding paragraphs will now be described with reference to FIG. 2.

The wear-leveling device 12 includes a communication interface hardware 24 which includes a communication interface 26 which is configured for transmitting/receiving control and/or data signaling to/from one or more other devices of system 10, such as PLD 14, another wear-leveling device 12, etc., which may be via one or more wired and/or wireless communication links.

The hardware 24 of wear-leveling device 12 further includes processing circuitry 28. The processing circuitry 28 may include a processor 30 and memory 32. In particular, in addition to or instead of a processor, such as a central processing unit, and memory, the processing circuitry 28 may comprise integrated circuitry for processing and/or control, e.g., one or more processors and/or processor cores and/or PLDs and/or ASICs (Application Specific Integrated Circuitry) adapted to execute instructions. The processor 30 may be configured to access (e.g., write to and/or read from) memory 32, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the wear-leveling device 12 may further comprise software 38, which is stored in, for example, memory 32 at the wear-leveling device 12, or stored in external memory (e.g., database, storage array, network storage device, etc.) accessible by the wear-leveling device 12. The software 38 may be executable by the processing circuitry 28.

The processing circuitry 28 may be configured to control any of the methods and/or processes described herein and/or to cause such methods, and/or processes to be performed, e.g., by wear-leveling device 12. The processor 30 corresponds to one or more processors 30 for performing wear-leveling device 12 functions described herein.

In some embodiments, the processing circuitry 28 of the wear-leveling device 12 may include a wear-leveling unit 20 configured for supporting wear leveling of the programmable resources in a PLD. The processing circuitry 28 may also include monitoring unit 22 configured for supporting monitoring/measuring one or more physical parameters/values/characteristics/etc. of one or more physical resources 16 of a PLD 14.

The wear-leveling device 12 includes a memory 32 that is configured to store data, programmatic software code and/or other information described herein. In some embodiments, the software 38 may include instructions that, when executed by the processor 30 and/or processing circuitry 28, causes the processor 30, processing circuitry 28, wear-leveling unit 20, and/or monitoring unit 22, to perform the processes described herein with respect to wear-leveling device 12.

Referring still to FIG. 2, PLD 14 may include memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Memory 40 may include a configured product bit-file 42 and/or configured monitoring bit-file 44 (i.e., received from and/or configured by wear-leveling device 12 via communication link 18).

PLD 14 may include and/or may be a device which includes a programmable logic device, such as an FPGA chip, a system on a chip including an FPGA or similar PLD, and/or a circuit board containing an FPGA and other devices (e.g., CPUs, microcontrollers, power circuitry etc.), or similar device. PLD 14 may include a plurality of physical resources 16 (e.g., an array of programmable logic gates, look-up tables, interconnects, interconnect switches, digital signal processing blocks, memory blocks, etc.). Wear-leveling device 12 and/or PLD 14 may be included, e.g., as part of a larger device, such as a network node, base station, radio access node, core node, wireless device, host computer, server, cloud computing node, etc. (not shown in FIG. 1 or FIG. 2).

In some embodiments, wear-leveling device 12 and PLD 14 are part of the same device, system, and/or component. For example, wear-leveling device 12 and PLD 14 may be implemented on a single circuit board (or several interconnected circuit boards) including a wear-leveling device 12 and a PLD 14. In some embodiments, wear-leveling device 12 and PLD 14 may be included in a single system-on-a-chip (SoC), for example, an SoC including processing circuitry 28 and physical resources 16 (e.g., a programmable logic array). In other embodiments, wear-leveling device 12 may be remote from PLD 14 (e.g., located in another module in the same device, located in a separate device, located in another premises, located in a remote data center, located in a cloud-based server, etc.).

PLD 14 further includes a communication interface 48 which is configured to transmit/receive data and/or control signaling from wear-leveling device 12 via communication link 18, which may be a wired and/or wireless communication link (and/or with any other entity of system 10), and which may be direct and/or indirect (e.g., with one or more intermediate devices, routers, relays, etc.) between the wear-leveling device 12 and PLD 14.

In FIGS. 1 and 2, the communication link 18 has been drawn as a dashed line to illustrate the communication between the wear-leveling device 12 and PLD 14, without explicit reference to any intermediary devices and the precise routing of messages/signaling via these devices, but it is to be understood that there may be one or more networks and/or intermediary devices between the wear-leveling device 12 and PLD 14.

In some embodiments, the inner workings of the wear-leveling device 12 and PLD 14 may be as shown in FIG. 2 and independently, the surrounding system topology may be that of FIG. 1.

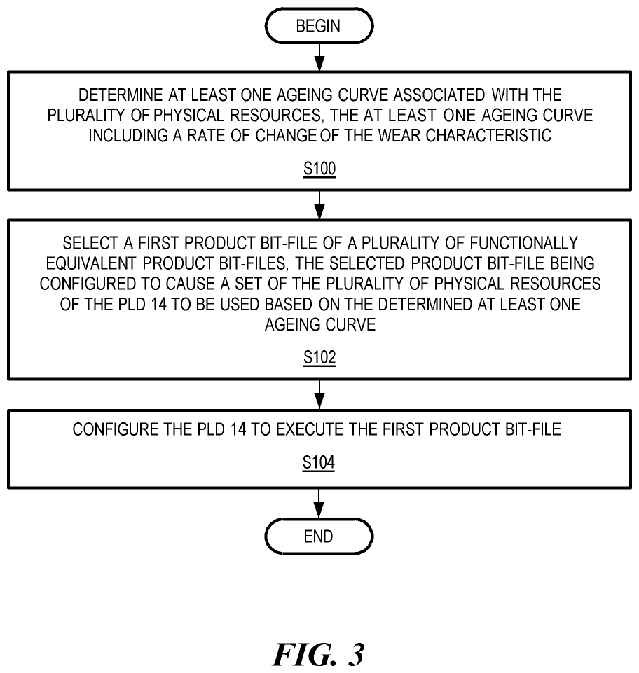

FIG. 3 is a flowchart of an example process in a device, such as a “wear-leveling” device 12 for monitoring wear/ageing/degradation/etc. of physical resources 16 (e.g., logic gates) in a PLD 14 and configuring the bit-files (e.g., product bit 42 file and/or monitoring bit-file 44) of the PLD 14 and/or programmable resources 16 based on the monitored wear, in order to level wear across the physical resources 16, and/or to extend the lifetime of the PLD 14. One or more blocks described herein may be performed by one or more elements of wear-leveling device 12 such as by one or more of processing circuitry 28 (including the wear-leveling unit 20 and/or monitoring unit 22), processor 30, memory 32, and/or communication interface 26. Wear-leveling device 12 is configured to determine (Block S100) at least one ageing curve associated with the plurality of physical resources, the at least one ageing curve including a rate of change of the wear characteristic. Wear-leveling device 12 is configured to select (Block S102) a first product bit-file of a plurality of functionally equivalent product bit-files, the selected product bit-file being configured to cause a set of the plurality of physical resources of the PLD to be used based on the determined ageing curve. Wear-leveling device 12 is configured to configure (Block S104) the PLD 14 to execute the first product bit-file.

In at least one embodiment, the at least one ageing curve may include a predicted future ageing curve. In at least one embodiment, the at least one ageing curve may be determined based on a historical ageing curve of the PLD 14. In at least one embodiment, the historical ageing curve may be based on the PLD 14 having been out of operation for at least one time period. In at least one embodiment, the at least one ageing curve may be based at least in part on a historical ageing curve of at least one other PLD. In at least one embodiment, the at least one other PLD may have a longer operational life than an operational life of the PLD 14. In at least one embodiment, the at least one ageing curve may be determined based on a discrepancy between an initial time delay of one of the plurality of physical resources at an initial state of the PLD 14, and a present time delay of the one of the plurality of physical resources. In at least one embodiment, the at least one ageing curve may be determined based on temperature information. In at least one embodiment, the temperature information may include a temperature-compensated delay corresponding to each of the plurality of resources. In at least one embodiment, the temperature information may correspond to a temperature model based on at least one of: at least one analytical model; at least one post place-and-route timing simulation performed at each of a plurality of temperatures; and an initial measurement at each of a plurality of temperatures performed in a climate control chamber. In at least one embodiment, the at least one ageing curve may be determined using a monitoring bit file, the first product bit-file being selected based on a determined ageing of the monitoring bit file.

Having described the general process flow of arrangements of the disclosure and having provided examples of hardware and software arrangements for implementing the processes and functions of the disclosure, the sections below provide details and examples of arrangements for wear-leveling of a PLD 14.

The PLD 14 circuitry may include ageing monitors that facilitate following the course of ageing in the PLD 14 circuitry through periodic measurements. An ageing curve may represent the course of ageing for a relatively small set of physical resources in a PLD, via a sensor that monitors those resources. There might be thousands of sensors in a monitoring bit-file to cover all PLD resources. Therefore, in each round of measurement a new delay value may be captured by each sensor and added to the previously collected delay values, thus forming an aging curve per each sensor over time.

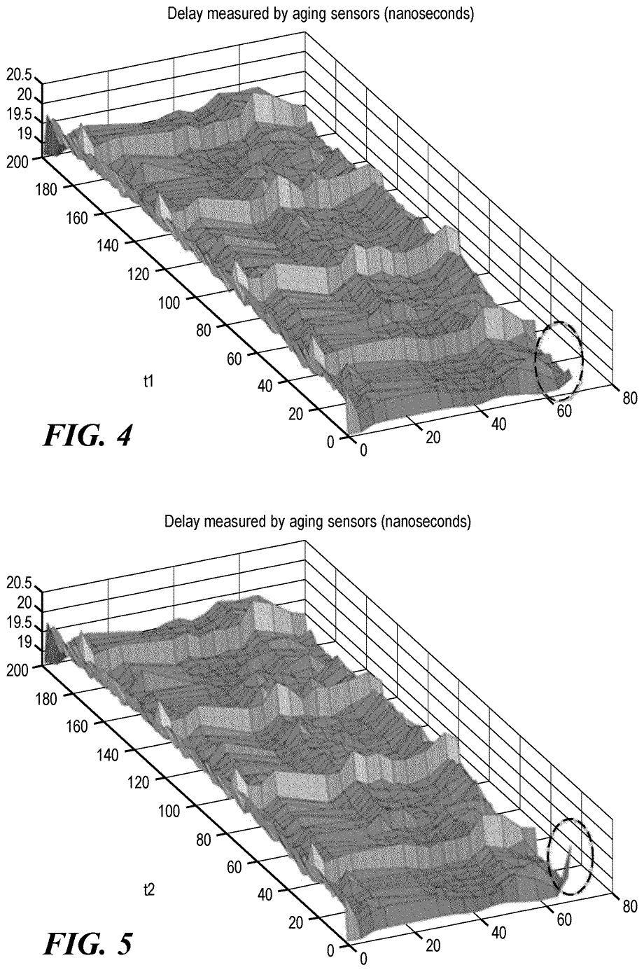

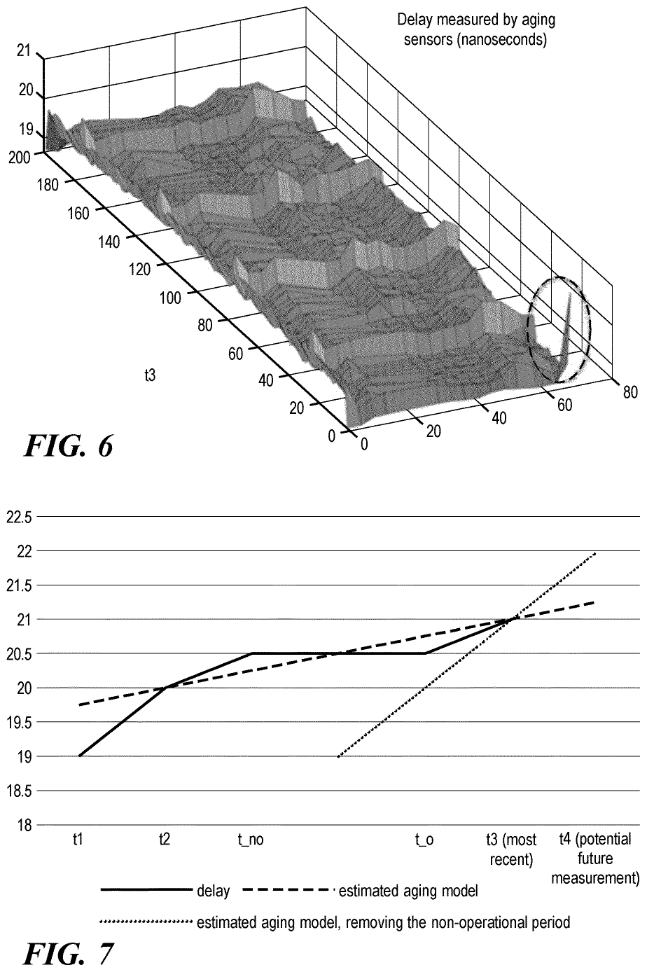

FIGS. 4-6 illustrate an example of three periodic measurements performed at times t1 (FIG. 4), t2 (FIG. 5), and t3 (FIG. 6), where the delay measured by the sensor marked with dashed oval has increased over time.

### Using Historical Data for Better Estimations

Considering each sensor individually, a historical curve can be created for the status of ageing in the resources monitored by that sensor. Referring to the example of FIGS. 4-6 (in which delay values measured via sensors are presented as surface plots), FIG. 7 uses a solid line to show how a historical delay curve for the highlighted sensor above might look, where the region between t_no and t_o represents the time during which the PLD 14 was non-operational. To enhance the wear-leveling method, both the current state of ageing as well as the future ageing developments may be considered by using the historical curves to create an estimation model that captures the speed of ageing. In FIG. 7, the two dotted lines are such example estimated ageing models for the monitored resources, where the slope of these lines can be used as an indicator for speed of ageing in the cost function.
The dashed line is obtained while disregarding that the PLD 14 has been non-operational for a while after the previous measurement (t2), and
The dotted line is obtained considering that the PLD 14 has been non-operational in the period between t_no and t_o.

In this example, the model that considers the period of inactivity captures a more realistic view of the ageing in the monitored resources, and shows a higher speed of ageing, highlighting the importance of basing the modeling on actual number of operational time instead of calendar time.

Performing Estimations by Using Historical Data from Other PLDs

In cases where the PLD 14 is constantly in use for extended periods of time, the wear leveling may be affected, as it may not be clear when the operation of the PLD 14 should be interrupted to avoid excessive ageing in its programmable resources (by, e.g., performing measurements and choosing a more suitable product bit-file). At least one embodiment may alleviate this situation by:
using measurements from other similar PLDs to interpolate/estimate the current state of ageing the PLDs that have fewer measurement points in their ageing curves. To be able to more efficiently compare curves coming from different PLDs, a floor may be introduced by performing an initial measurement for each sensor on each PLD. This is later used to normalize future measurements, which may be used to predict how the current curve will look like in the future.
using data from PLDs that have a longer operational life to perform estimates for the “younger” PLDs.

In this context, similar PLDs are those for which the historical delay curves are similar. Such similarity can, for example, be established through statistical methods. Factors that contribute to having similar curves are, for example, the PLDs having similar technical specifications, being used in similar products, etc.

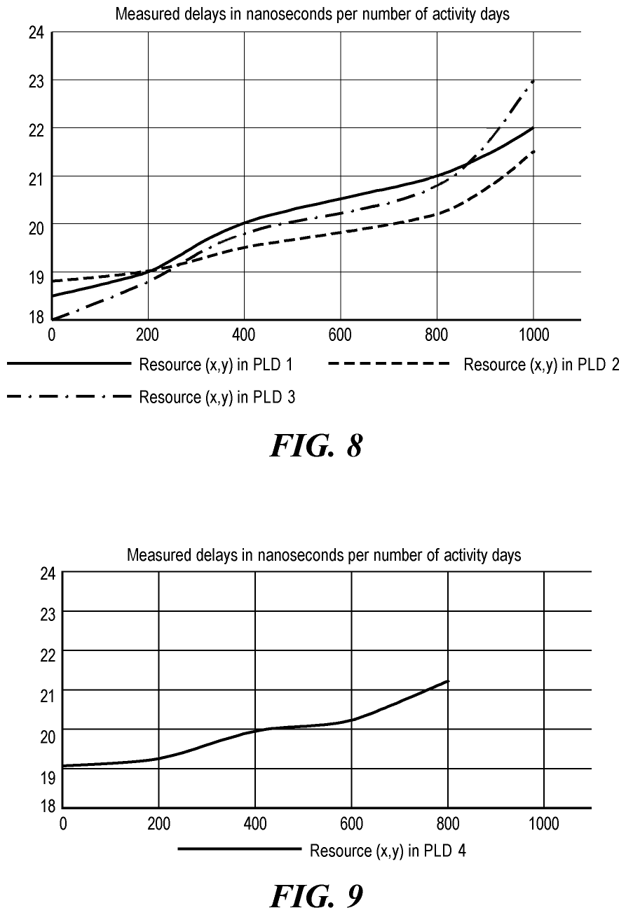

The graphs of FIGS. 8 and 9 are examples that illustrate this concept. FIG. 8 shows the historical delay data for three PLDs numbered 1-3 (which may be, e.g., three PLDs 14) that have been in use for more than 1,000 working days. FIG. 9 shows delay data for PLD number 4 (e.g., a fourth PLD 14) that lacks any measurement after working day 800. In this case, after establishing similarity between historical curves of PLDs nos. 1-3 and PLD no. 4, it is possible to use delay curves of PLDs nos. 1-3 to predict the ageing in PLD no. 4, thus giving more information to calculate the current speed of ageing to be used in the evaluation of the cost functions.

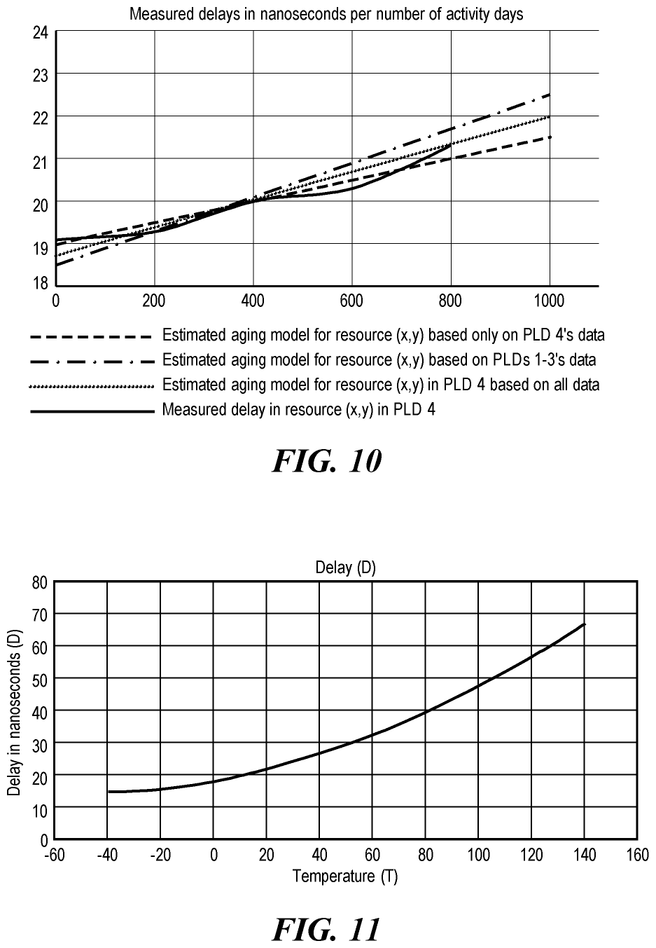

As an illustrative example, FIG. 10 shows again the measured delays for resource (x,y) in PLD no. 4, and additionally shows:
1) the estimated ageing model obtained using historical delay data only from PLD no. 4;
2) the estimated ageing model based on data from PLDs nos. 1-3, and
3) the estimated ageing model for Resource (x,y) in PLD no. 4, based on the two abovementioned models.

Thus, it is possible to improve the estimation of the ageing model based on data available from other PLDs.

### Compensating for the Effect of Temperature on Measurements

Since the ambient and device temperatures may affect the measured delay, some embodiments separate the delay component that is due to ageing from the delay component that is due to the temperature changes. This may be accomplished with a model that provides the temperature-dependent component of the delay. The example of FIG. 11 shows such a delay.

The curve depicted in FIG. 11 may be obtained for each element in the resource map (described below) of the PLD 14. However, depending on the choice of the delay-temperature model, one model can serve all PLDs 14 of the same type (though in some cases it may be necessary to have one model for each resource element, e.g., in case the ageing sensors are not uniform), or one model per resource element per PLD 14. The following are examples of how such models can be obtained:
analytical models,
post place-and-route timing simulations at different temperatures, or
initial measurements at different temperatures in a climate control chamber, either on each PLD 14 unit or on a representative set of PLD units). This approach may give the most accurate results in terms of removing the temperature-dependent component of the delay.

Performing the temperature compensation may require collecting data even from on-chip temperature sensors so that, if accurate data on ambient temperature is unavailable, the sensor data could be used instead.

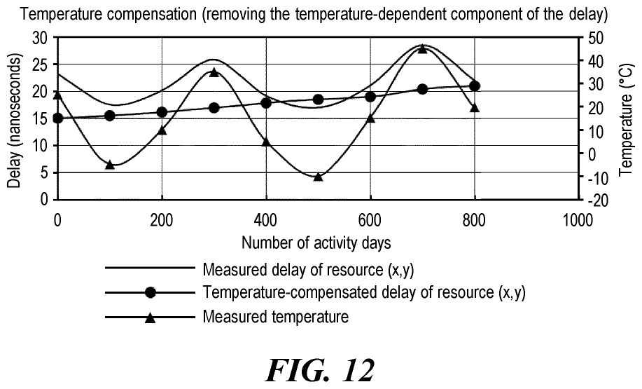

Thus, a more accurate wear leveling may involve collecting historical delay data (delay curves) as well as temperature data, so that at any given point in time (tn), the temperature, the delay, and the speed of changes in the delay may be considered in the cost function to choose the next product bit-file, such that lifetime can be maximized. FIG. 12 illustrates such temperature compensation for a given resource (x,y) in a given PLD 14.

By using a curve such as that of FIG. 11 (referred below as delay-temperature curve C), the measured delay at any given temperature can be converted to its corresponding temperature-compensated delay D value for the reference temperature (e.g., −40). For each resource at location (x,y) it is possible to obtain one such delay-temperature curve (C) during the initial measurements. The measured delay at location (x,y) at temperature T (represented by

$${D}_{x , y}^{M T} )$$

can then be converted to a temperature-compensated delay D_{x,y} by using the following formula:

$${D}_{x , y} = {D}_{x , y}^{M , T} - {D}_{x , y}^{C} ( T )$$

Where

$${D}_{x , y}^{C} ( T )$$

represents the additional delay caused by the higher temperature (obtained from curve C mentioned above), that may be subtracted from the measured delay, to obtain the part of delay that is purely caused by ageing.

### Selecting the Next Product Bit-File

To perform the wear leveling for product P (that is, a given PLD unit), the following cost function may be used to choose the next product bit-file b:

$$C ( P , b ) = {\sum }_{x} {\sum }_{y} {p}_{x , y}^{b} \times {( α {D}_{x , y} + β {R}_{x , y} )}^{f ( x , y )} \{ ω ( 1 - {u}_{x , y}^{b} ) + ( 1 - ω ) {u}_{x , y}^{b} \}$$

where:

$${p}_{x , y}^{b} ∈ \{ 0 , 1 \}$$

indicates whether resource (x,y) for product bit-file b is powered on,
D_{(x,y)} represents the measured and temperature-compensated delay for resource (x,y),
R_{(x,y)} represents the speed (rate) of ageing for resource (x,y), based on the estimated ageing model.
ƒ(x,y) can be a constant or a function adjusting the cost ratio for a resource compared to the other resources (can be used to change the cost based on, e.g., the type of resource, the current value of the delay),

$${u}_{x , y}^{b} ∈ \{ 0 , 1 \}$$

indicates whether the resource in that location is used in the product bit-file b,
ω∈[0,1] is a ratio that specifies the importance of the static type of ageing compared with that of the dynamic type of ageing; and
α and β are weights assigned to the measured delay values, namely, D_{x,y} and ΔD.

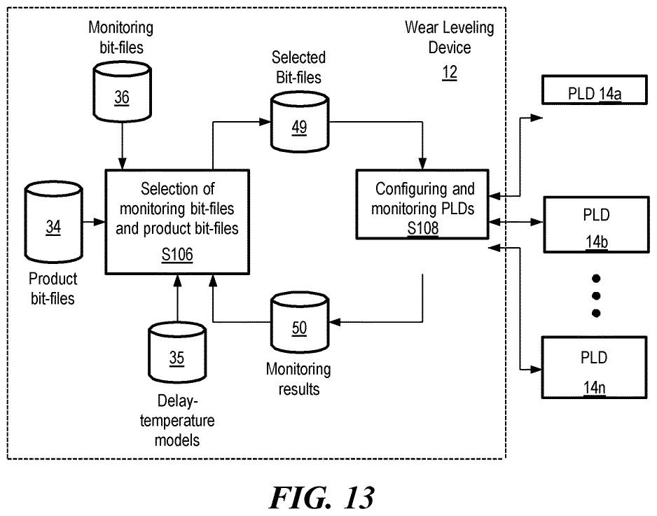

FIG. 13 is a flowchart of another example process in a wear leveling device for wear leveling the programmable resources in a PLD 14 according to some embodiments of the present disclosure. The solid arrows in the diagram show the direction of information flow. The functions/modules depicted in FIG. 13 may be implemented by and/or may correspond to the elements depicted in FIG. 1 and FIG. 2, including one or more of processing circuitry 28 (including the wear-leveling unit 20 and/or monitoring unit 22), processor 30, memory 32, and/or communication interface 26.

Referring to FIG. 13, in some embodiments, each of the product bit-files 34 and monitoring bit-files 36 may be a database (e.g., stored in memory 32, downloadable via a remote server (not shown), etc.), containing bit-files that are dedicated to monitoring for ageing, where each bit-file is populated with ageing monitors (sensors) and the associated control logic (e.g., by the wear-leveling unit 20 and/or monitoring unit 22). To have thorough monitoring coverage for the physical resources 16 in the PLD 14, more than one bit-file may be used. For each deployment to the product (i.e., the PLD 14 or a device containing the PLD 14, a subset of these bit-files may be selected by wear-leveling device 12 (e.g., by the wear-leveling unit 20 and/or monitoring unit 22) (Step S106), which then merges the result of the monitoring from each bit-file with the previous monitoring results history to obtain a complete coverage of the resources. As an example, the physical resources 16 area may be analogized to as a checkerboard layout where the dark squares are covered by one bit-file and the light squares are covered by another bit-file. Superimposing (merging) the results of these two monitoring bit-files would thus give a complete coverage of the resources. In some embodiments, if the same resource is covered by more than one monitoring bit-file (either in the same deployment or in different deployments), the latest result (e.g., most recent result) may override the previous ones, and/or may be averaged into a running average of results for that resource (e.g., by the wear-leveling unit 20 and/or monitoring unit 22).

In some embodiments, delay-temperature models 35 may be models relating to the delay-temperature as described elsewhere herein and may be a database (e.g., stored in memory 32, downloadable via a remote server (not shown), etc.).

Product bit-files 34 may be a database of bit-files (e.g., stored in memory 32 and/or downloadable via a remote server), which may include information about the placement and routing properties of a given product bit-file (e.g., which physical resources 16 to use and how they are interconnected). Each bit-file in this database may contain the mission mode circuitry for the product, for example. Each bit-file may be functionally equivalent to all other product bit-files in this database, but may have different placement and routing properties. To achieve different placement and routing properties, a variety of tools may be used, such as randomization which may be introduced into the placement and routing process. In some embodiments, randomness is introduced by accepting a (randomization) seed as an input parameter into the routing/placement build process (e.g., using a PLD development/build tool). In other embodiments, randomness may be achievable via other means, such as using different combinations of the following methods for each build:
different synthesis and place & route strategies,
different number of parallel threads for running the build,
different machines or virtual machines (a change in parameters such as processor architecture, number of cores, OS type, OS version and installed patches, physical and virtual memory sizes, may each make the machine appear as a different machine), and
changing source file names.

Other randomization/variation-inducing techniques may be used for generating a variety of functionally equivalent product bit-files without deviating from the scope of the present disclosure. These techniques may be implemented by a wear-leveling device 12 and/or by a remote device (e.g., remote server) which generates the various different but functionally equivalent product bit-files using build/development tools in conjunction with the above-described randomization techniques.

As a result of the introduced randomization, each bit-file may use a different set or sets of programmable resources 16 and/or power regions.

Selected bit-files 49 may be a database (e.g., stored in memory 32 and/or downloadable via a remote server) containing a pair of (configured) monitoring and product bit-files for each product (e.g., configured monitoring bit-file 44 and configured product bit-file 42). In some embodiments, these pairs may be chosen by the wear-leveling device 12 (e.g., by the wear-leveling unit 20 and/or monitoring unit 22), for configuring PLD 14 (e.g., via an update package).

Monitoring results may be a monitoring results database 50 (e.g., stored in memory 32 and/or downloadable via a remote server) containing the monitoring results (both the latest and history) collected from products, which may be generated/maintained/updated by, e.g., monitoring unit 22. Each set of results may be marked (e.g., by monitoring unit 22) with the ID of the monitoring bit-file used to obtain it.

In some embodiments, system management and monitoring, i.e., configuring and monitoring (e.g., by the wear-leveling unit 20 and/or monitoring unit 22) the PLDs 14 (Step 108) may include periodic deployment of selected (monitoring and product) bit-file pairs to each product, and periodic collecting of the monitoring results back from the PLDs 14, and storing them in the monitoring results database 50.

It should be noted that the above components/steps may be considered logical entities-shown separately for the purpose of clarity—and can in practice be merged in a physical implementation, or may be distributed among multiple physical entities/devices. For example, the five storage components 34, 35, 36, 49, and 50, can be implemented as a single database, so that instead of transferring “selected bit-file” only a pointer to it needs to be transferred.

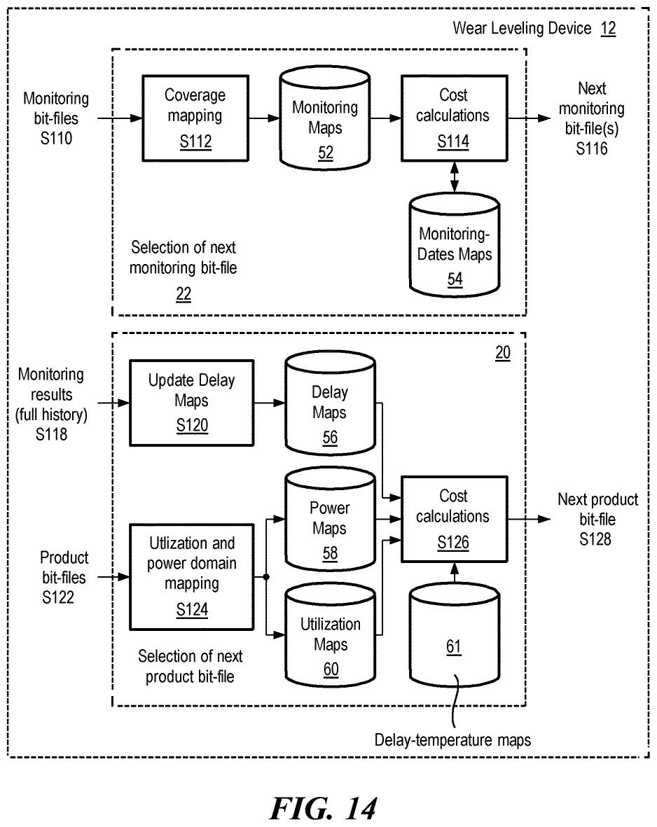

FIG. 14 is a flowchart of another example process in a wear leveling device 12 for wear leveling the programmable resources/physical resources 16 in a PLD 14 according to some embodiments of the present disclosure. In this example, the wear-leveling system/process includes two subprocesses/subsystems, selection of the next monitoring bit-file (e.g., the next configured monitoring bit-file 44), and selection of the next product bit-file (e.g., the next configured product bit-file 42). One or both subsystems may use cost functions to assign costs to the respective bit-files, and for choosing the one that yields the lowest cost. As shown in the example of FIG. 14, the selection of next monitoring bit-file 44 is performed by the monitoring unit 22, and the selection of next product bit-file 42 is performed by wear-leveling unit 20. In other embodiments, these functions may be performed by wear-leveling unit 20 and/or monitoring unit 22 and/or other circuitry/devices/etc.

Referring to FIG. 14, in the selection of next monitoring bit-file sub-process (e.g., as performed by monitoring unit 22), first, the monitoring bit-files 36 (Step S110) are provided (e.g., from memory 32, from a remote server, etc.). A coverage mapping is performed (Step S112), which generates monitoring maps 52 (e.g., which may be a data structure, such as a mapping of physical resources 16 to be monitored). A monitoring-dates map 54 is a data structure which includes information regarding when physical resources 16 were previously monitored, such as a mapping of physical resources to timestamps or similar time/date information). Cost calculations (i.e., a cost function) are performed (Step S114) based on the monitoring maps 52 and/or monitoring-dates map 54. The cost calculations (e.g., metrics) are used to select/determine (Step S116) the subsequent monitoring bit-files (e.g., configured monitoring bit-file 44 of FIG. 2) for configuring the PLD 14, and may also be used to update the monitoring-dates map 54. In some embodiments, these functions may be performed by the wear-leveling unit 20 and/or monitoring unit 22.

Referring still to FIG. 14, in the selection of next product bit-file sub-process (e.g., as performed by wear-leveling unit 20), the monitoring results (e.g., a full history or partial history) are provided (Step S118) to update, e.g., the delay maps (Step S120), for determining/updating delay maps 56. Delay maps 56 may be a data structure, e.g., mapping physical resources 16 to corresponding delay information/metrics/parameters/etc. Product bit-files are provided (Step S122) for utilization and power domain mapping (Step S124), which determines/updates power maps 58, utilization maps 60, and delay-temperature maps 61. A power map 58 may be a data structure, e.g., a mapping physical resources 16 to corresponding power information associated with one or more of the product bit-files. A utilization map 60 may be a data structure, e.g., a mapping of physical resources 16 to corresponding utilization information associated with the one or more product bit-files. A delay-temperature map 61 may be a data structure, e.g., a mapping physical resources 16 to corresponding delay-temperature information associated with one or more of the product bit-files One or more of the delay maps 56, power maps 58, utilization maps 60, and delay-temperature maps 61 may be used (e.g., by wear-leveling unit 20) for cost calculations (S126) (e.g., a cost function), to generate/determine/select/configure the next product bit-file (Step S128), e.g., for configuring PLD 14 (e.g., configured product bit-file 42 of FIG. 2). In some embodiments, one or more of these functions may be performed by the wear-leveling unit 20 and/or monitoring unit 22.

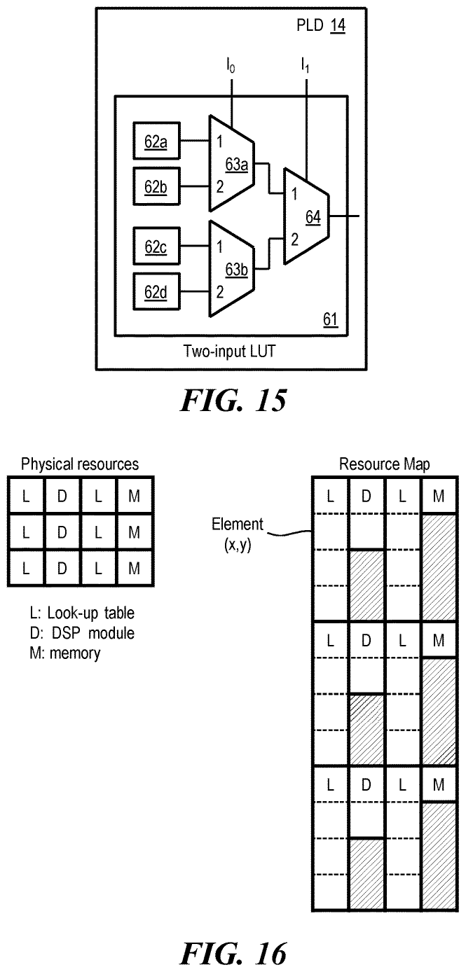

In some embodiments, a data structure referred to as a “Resource Map” may be used (e.g., by one or both sub-processes illustrated in FIG. 14) for storing different properties (such as delay or utilization) for the PLD physical resources 16, as described herein. Physical resources 16 in a PLD 14 may in some cases be arranged in a two-dimensional array, where typically all resources in a column are of the same type. Each physical resource 16 may be used in multiple different setups where, in each setup, only part of the internal circuitry of that resource may be used. FIG. 15 illustrates an example two-input look-up table (LUT) 61 for storage elements 62a, 62b, 62c, and 62d, including inner multiplexers 63a and 63b controlled by input I0, and an output multiplexer 64 controlled by input I1. In the example of FIG. 15, four possible configurations may be considered: (1) both inputs I1 and I2 are used, (2) only the input I2 controlling the output multiplexer 64 is used (while the other input I1 is tied to a constant), (3) only the input I1 controlling the inner multiplexers 63a and 63b is used (while the other input I2 is tied to a constant), and/or (4) both inputs I1 and I2 are tied to a constant.

In some embodiments, to be able to monitor and perform wear leveling for each resource setup, wear-leveling unit 20 and/or monitoring unit 22 may configure the various maps described herein by considering one or more (i.e., each) element in the physical array of resources 16, where the resource map may be divided into and/or extended into additional rows to allow for storing different properties (such as delay) associated to different setups of that type of resource. This array augmented with such additional rows may be referred to herein as a “Resource Map”. For example, in both sub-processes of wear leveling device 12 depicted in FIG. 14, different sets of instances of this “Resource Map” may be used, namely, a Monitoring-Dates Map 54, a Delay Map 56, a Monitoring Map 52, a Utilization Map 60, and a Power Map 58, etc. As an example, FIG. 16 illustrates example utilization and configuration of physical resources in a PLD 14 where, in the corresponding Resource Map (which may be made up of or representative of elements, where each element may be represented and/or characterized by (x,y) values representing, e.g., the element's row and column values in the map), additional rows are used for storage of properties for four setups of two-input LUTs and two setups for digital signal processing modules (DSPs).

### Example Selection of Next Monitoring Bit-File

In some embodiments, monitoring of ageing for each type of resource of the physical resources 16 in a PLD 14 may utilize various different types of circuitry. In some embodiments, the wear-leveling device 12 and/or PLD 14 may be configured to monitor the increasing trend in the delays of the physical resources 16 (e.g., delays of propagating signals from one resource/circuit element/logic gate/etc. to another). In some embodiments, these functions may be performed by the wear-leveling unit 20 and/or monitoring unit 22.

Some examples of monitoring circuitries for different type of physical resources 16 include:
for look-up tables, carry-chains, multiplexers, interconnect switches, and interconnect, the use of ring-oscillators may be effective in detecting, e.g., small delay differences between physical resources 16, and as a circuit ages, the speed of oscillation typically reduces, thus providing a measurement/parameter of ageing;
for digital signal processing blocks, monitoring techniques such as transition probability monitoring may be effective for measuring ageing parameters;
for memories, memory built-in self-test (MBIST) with frequency sweeping can be used to provide measurements/parameters of ageing.

Other techniques for monitoring ageing/degradation/etc. of physical resources 16 in a PLD 14 may be used without deviating from the scope of the present disclosure.

In some monitoring methods, for example, the measured frequency of operation is an indicator of delay in the monitored physical resources 16, and therefore, observing the trends in change of frequencies (and the corresponding delays) may reveal degradation in those physical resources 16, including gradual degradation.

In some embodiments, it may be impractical to monitor all physical resources 16 by using a single monitoring bit-file due to the following reasons:
some of the physical resources 16 may be needed for the implementation of the control circuitry, and thus may not be available for monitoring (depending on the type(s) of monitoring used);
it might not be practical to include all internal circuitry of all physical resources 16, because inclusion of different parts of the internal circuitry might require a different configuration of the resource. Even if the design of the PLD 14 allows for a dynamic reconfiguration of the resource by using the same bit-file, the circuitry needed to control that dynamic reconfiguration will itself take some physical resources 16, thus possibly preventing those physical resources 16 from being configured as monitored circuitry.

Thus, in some embodiments, multiple monitoring bitstreams/bit-files may be used.

In some embodiments, wear-leveling device 12 (e.g., wear-leveling unit 20 and/or monitoring unit 22) is configured to use multiple monitoring bit-files (i.e., to configure PLD 14 with the multiple monitoring bit-files and measure/receive the results) for achieving a complete (or sufficiently comprehensive) coverage of all or most of the physical resources 16 and their internal circuitries. This may be done, e.g., by using an iterative approach, in which all available monitoring bit-files are used in every round of measurement. However, such an approach may not be always possible within the allowed timespan for measurement and swapping of product bit-files. Therefore, in some embodiments, the monitoring processes are performed selectively/periodically over time. Thus, some embodiments of the present disclosure may employ a strategy for selecting the next monitoring bit-file based on how many of the least-recently-monitored physical resources 16 it covers by its monitoring circuitry. For example, to perform the selection, two instances of Resource Map may be used and maintained (e.g., by monitoring unit 22):
Monitoring Map 52 is an instance of Resource Map per monitoring bit-file in which each element

$${u}_{x , y}^{b} ∈ \{ 0 , 1 \}$$

stores whether the element (x,y) is monitored by monitoring bit-file b or not, and
Monitoring-Dates Map 54 is an instance of Resource Map per product in which each element

$${t}_{x , y}^{P}$$

stores the last time (e.g., in number of days since a reference time, such as, e.g., Unix Epoch or production date, etc.) that the circuitry corresponding to that element has been monitored for product P.

In some embodiments, to select the next monitoring bit-file, the following cost function is calculated (e.g., by monitoring unit 22) for each monitoring bit-file for each product P and the one with minimum cost is chosen as the next monitoring bit-file for that product:

$$C ( t , u , n , T , b , P ) = {\sum }_{x} {\sum }_{y} {n}_{x , y} [ {t}_{x , y}^{P} \times {u}_{x , y}^{b} + ( 1 - {u}_{x , y}^{b} ) \times T ]$$

where T is the current date's number of days since the reference time (used to penalize the monitoring bit-file for the physical resources 16 it does not cover) and n_{x,y} is a normalization factor used to equalize the weight of different types of physical resources 16 in the cost function (especially since there is typically an imbalance between the total number of different types of physical resources 16 in a PLD 14. In order for all resource types to have the same weight in the cost calculation, n_{x,y} is set to the inverse of total number of physical resources 16 of the same type as element (x,y). In some embodiments, these cost calculation functions may be performed by the wear-leveling unit 20 and/or monitoring unit 22.

### Selection of Next Product Bit-File

There are several factors that may affect the choice of the next product bit-file, including what physical resources 16 are used in each bit-file, which type of ageing are to be minimized, and if power gating is available in the targeted PLD 14. In some embodiments, these factors may be included in a cost function and the bit-file incurring the least cost will be selected as the next product bit-file. To calculate the cost function (e.g., by wear-leveling unit 20) two additional instances of Resource Map may be used and maintained:
“Delay Map” 56 is an instance of Resource Map per product in which each element

$${d}_{x , y}^{P}$$

represents the delay for the circuitry corresponding to that element (x,y) (obtained via historical monitoring results) for product P. Delay Map 56 may be updated every time a set of new monitoring results are added to the Monitoring Results database 50, for example.
“Utilization Map” is an instance of Resource Map per product bit-file in which each element

$${u}_{x , y}^{b} ∈ \{ 0 , 1 \}$$

stores whether the circuitry corresponding to that element is utilized by product bit-file b or not. Set of Utilization Maps 60 may be updated whenever a new product bit-file is added to the Product Bit-files database, for example. In some embodiments, these functions may be performed by the wear-leveling unit 20 and/or monitoring unit 22.

In the following, the cost function calculation (e.g., as performed by wear-leveling unit 20, monitoring unit 22, etc.) is described in incremental steps, where in each additional step, an additional factor is used in the decision making.

### Wear Leveling for Dynamic Ageing

In some embodiments, to perform wear leveling for dynamic ageing, the cost function C(d,u,b,P) may be calculated for each product bit-file b and for each product P, and the bit-file yielding the minimum cost may be selected as the next product bit-file:

$$C ( d , u , b , P ) = {\sum }_{x} {\sum }_{y} {d}_{x , y}^{P} \times {u}_{x , y}^{b}$$

where

$${d}_{x , y}^{P} and {u}_{x , y}^{b}$$

are taken from Delay Map 56 and Utilization Map 60 described above.

In some embodiments, the above cost function may account for dynamic ageing which affects CMOS circuitry when there is switching activity, and therefore, a product bit-file that uses physical resources 16 with higher observed delays may be penalized for those used physical resources 16 by the amount of observed delay.

In some embodiments, these functions may be performed by the wear-leveling unit 20 and/or monitoring unit 22.

### Wear Leveling for Both Dynamic and Static Ageing

Depending on the technology used in fabrication of the PLD 14, the internal circuitry might be affected by both static and dynamic types of ageing, but with different degrees for each type of ageing. Therefore, to perform wear leveling, some embodiments consider whether a hardware resource is used or not, and thus whether it can be affected to some degree by either type of ageing. For example, some embodiments utilize a coefficient ω (where 0≤ω≤1) that represents the importance (dominance) of “static ageing” mechanisms relative to the importance of “dynamic ageing” mechanisms. For example, if for a technology node, static ageing due to BTI is extremely important while dynamic ageing due to HCI can be disregarded, ω=1 will be chosen. By using a, a cost function C(d,u,ω,b,P) as shown below may be calculated (e.g., by wear-leveling unit 20) for each product bit-file b:

$$C ( d , u , ω , b , P ) = {\sum }_{x} {\sum }_{y} {d}_{x , y}^{P} \{ ω ( 1 - {u}_{x , y}^{b} ) + ( 1 - ω ) {u}_{x , y}^{b} \}$$

It should be noted that if ω=0.5 (meaning that static and dynamic ageing have the same significance),

$${u}_{x , y}^{b}$$

will be cancelled out altogether from the cost function resulting in the same cost for all bit-files in the repository (essentially implying that the rotation/alternating of the product bit-files cannot be used to perform wear leveling).

In some embodiments, these functions may be performed by the wear-leveling unit 20 and/or monitoring unit 22.

### Wear Leveling for Both Dynamic and Static Ageing, Using Power Gating

In some embodiments, the design of some PLDs 14 may allow for powering off the unused physical resources 16 (e.g., grouped under separate power regions, and/or according to other groupings). The powering off may be configured automatically by the synthesis tools, or explicitly defined by a user/developer. In some embodiments, the circuitry inside a switched off region may not be affected by either of the ageing types (i.e., static or dynamic). To take this knowledge into account in choosing the next product bit-file, another instance of Resource Map called “Power Map” 58 may be used (e.g., by wear-leveling unit 20) in some embodiments.

In some embodiments, “Power Map” 58 is an instance of Resource Map per product bit-file in which each element

$${p}_{x , y}^{b} ∈ \{ 0 , 1 \}$$

may store whether the circuitry (i.e., physical resources 16) corresponding to that element is powered on by product bit-file b or not. The Set of Power Maps 58 may be updated whenever a new product bit-file is added to the Product Bit-files database, for example.

Using Power Maps 58, a cost function C(d,u,p,ω,b,P) as shown below may be calculated (e.g., by wear-leveling unit 20) for each product bit-file b according to:

$$C ( d , u , p , ω , b , P ) = {\sum }_{x} {\sum }_{y} {p}_{x , y}^{b} \times {d}_{x , y}^{P} \{ ω ( 1 - {u}_{x , y}^{b} ) + ( 1 - ω ) {u}_{x , y}^{b} \}$$

In the above cost function, in some embodiments, if circuitry (i.e., physical resources 16) corresponding to element (x,y) in Resource Map is powered off in a given product bit-file, the delay corresponding to that element may be removed from the cost.

In some embodiments, these functions may be performed by the wear-leveling unit 20 and/or monitoring unit 22.

### Wear Leveling for Both Dynamic and Static Ageing, Using Power Gating and Weighted Delays

$$C ( d , u , b , P , f ) = {\sum }_{x} {\sum }_{y} {( {d}_{x , y}^{P} )}^{f ( x , y )} \times {u}_{x , y}^{b}$$

In some embodiments and use cases, at least part of the physical resources 16 may have a much higher delay compared with the other physical resources 16. For such cases, by using the exponent ƒ(x,y) for the delay values, for example, a higher weight/cost may be assigned (e.g., by wear-leveling unit 20) to the physical resources 16 that have high delays. In some embodiments, the function ƒ(x,y) can simply be a constant, or can be initialized based on monitoring results. This kind of weighting may be applied to one or more of the three cost functions described herein.

In some embodiments, these functions may be performed by the wear-leveling unit 20 and/or monitoring unit 22.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A device including processing circuitry in communication with a programmable logic device (PLD), the PLD including a plurality of physical resources and a plurality of sensors, each of the plurality of physical resources having a wear characteristic measurable by a corresponding one of the plurality of sensors, the processing circuitry being configured to:
determine at least one ageing curve associated with the plurality of physical resources, the at least one ageing curve including a rate of change of the wear characteristic;
select a first product bit-file of a plurality of functionally equivalent product bit-files, the selected product bit-file being configured to cause a set of the plurality of physical resources of the PLD to be used based on the determined at least one ageing curve; and
cause the PLD to execute the first product bit-file.

2. The device of claim 1, wherein the at least one ageing curve includes a predicted future ageing curve.

3. The device of claim 1, wherein the at least one ageing curve is determined based on a historical ageing curve of the PLD.

4. The device of claim 3, wherein the historical ageing curve is based on the PLD having been out of operation for at least one time period.

5. The device of claim 1, wherein the at least one ageing curve is based at least in part on a historical ageing curve of at least one other PLD.

6. The device of claim 5, wherein the at least one other PLD has a longer operational life than an operational life of the PLD.

7. The device of claim 1, wherein the at least one ageing curve is determined based on a discrepancy between an initial time delay of one of the plurality of physical resources at an initial state of the PLD, and a present time delay of the one of the plurality of physical resources.

8. The device of claim 1, wherein the at least one ageing curve is determined based on temperature information.

9. The device of claim 8, wherein the temperature information includes a temperature-compensated delay corresponding to each of the plurality of resources.

10. The device of claim 8, wherein the temperature information corresponds to a temperature model based on at least one of:
at least one analytical model;
at least one post place-and-route timing simulation performed at each of a plurality of temperatures; and
an initial measurement at each of a plurality of temperatures performed in a climate control chamber.

11. The device of claim 1, wherein the at least one ageing curve is determined using a monitoring bit file, the first product bit-file being selected based on a determined ageing of the monitoring bit file.

12. A method implemented in a device in communication with a programmable logic device (PLD), the PLD including a plurality of physical resources and a plurality of sensors, each of the plurality of physical resources having a wear characteristic measurable by a corresponding one of the plurality of sensors, the method comprising:
determining at least one ageing curve associated with the plurality of physical resources, the at least one ageing curve including a rate of change of the wear characteristic;
selecting a first product bit-file of a plurality of functionally equivalent product bit-files, the selected product bit-file being configured to cause a set of the plurality of physical resources of the PLD to be used based on the determined at least one ageing curve; and
configuring the PLD to execute the first product bit-file.

13. The method of claim 12, wherein the at least one ageing curve includes a predicted future ageing curve.

14. The method of claim 12, wherein the at least one ageing curve is determined based on a historical ageing curve of the PLD.

15. The method of claim 14, wherein the historical ageing curve is based on the PLD having been out of operation for at least one time period.

16. The method of claim 12, wherein the at least one ageing curve is based at least in part on a historical ageing curve of at least one other PLD.

17. The method of claim 16, wherein the at least one other PLD has a longer operational life than an operational life of the PLD.

18. The method of claim 12, wherein the at least one ageing curve is determined based on a discrepancy between an initial time delay of one of the plurality of physical resources at an initial state of the PLD, and a present time delay of the one of the plurality of physical resources.

19. The method of claim 12, wherein the at least one ageing curve is determined based on temperature information.

20. The method of claim 19, wherein the temperature information includes a temperature-compensated delay corresponding to each of the plurality of resources.

21. The method of claim 19, wherein the temperature information corresponds to a temperature model based on at least one of:
at least one analytical model;
at least one post place-and-route timing simulation performed at each of a plurality of temperatures; and
an initial measurement at each of a plurality of temperatures performed in a climate control chamber.

22. The method of claim 12, wherein the at least one ageing curve is determined using a monitoring bit file, the first product bit-file being selected based on a determined ageing of the monitoring bit file.
